(19) United States
(12) Patent Application Publication
(10) Pub. No.: US 2026/0225479 A1
(43) Pub. Date: Aug. 6, 2026

(54) ELECTRIC VEHICLE CHARGING SYSTEM

(71) Applicant: Tritium Power Solutions Pty Ltd, Narre Warren South VIC (AU)

(72) Inventors: David Andrew FINN, Narre Warren South VIC (AU); Calem Timothy WALSH, Narre Warren South VIC (AU); Aidan Michael CLARKE, Narre Warren South VIC (AU); James McFarlane KENNEDY, Narre Warren South VIC (AU); Benjamin GUYMER, Narre Warren South VIC (AU); Michael John WALTON, Narre Warren South VIC (AU)

(73) Assignee: Tritium Power Solutions Pty Ltd, Narre Warren South VIC (AU)

(21) Appl. No.: 19/150,870

(22) PCT Filed: Jan. 25, 2024
(86) PCT No.: PCT/AU2024/050048

§ 371 Date: Jul. 24, 2025

(30) Foreign Application Priority Data
Jan. 25, 2023 (AU) 2023900180

(51) Int. Cl. B60L 53/14; B60L 53/30; H02H 3/08

(52) U.S. Cl. CPC B60L 53/14; B60L 53/30; H02H 3/08; B60L 2210/10; B60L 2210/30

(57) ABSTRACT

An electric vehicle charging system. The EV charging system includes an AC/DC (Alternating Current/Direct Current) rectifier having an input connected to an AC power supply and an output for outputting a DC output and being configured to convert an AC input from the AC power supply to the DC output at a first voltage, and one or more electric protection circuits for connecting the AC/DC rectifier to a charging assembly or another AC/DC rectifier.

### TECHNICAL FIELD

The present invention relates to an electric vehicle charging system.

### BACKGROUND

Any references to methods, apparatus or documents of the prior art are not to be taken as constituting any evidence or admission that they formed, or form part of the common general knowledge.

As EV charging stations proliferate, and charging sites become larger, key problems have emerged regarding the way that sites are configured. Sites which are poorly matched to the local vehicle charging demand can be very expensive and unprofitable to install and operate. As the EV market is expected to rapidly expand, and the payoff period of charge stations is measured in years, there is a fine line between a future-proofed site and a drastically under-utilized site. Additionally, charging stations must fit into the built environment in a variety of brownfield and greenfield sites with different layout objectives. Of further note, installation and balance of system costs can make up a large piece of the overall upfront capital expenditure.

Charging station architectures can broadly be categorized mainly by the location of the power conversion devices and galvanic isolation barrier (near the vehicle, or further away in a more convenient space).

### Power Conversion Devices at the Carpark

This architecture, sometimes referred to as stand-alone charge station, has a very large charging pillar with all of the required conversion technology, and fed from a conventional Low-voltage AC feed. These charge stations are enormous, unattractive, and can be difficult to locate without surrendering carparking space. They can be fitted with as many as 4 cables, however the cable management and carpark location options become complicated. Additionally, drivers must follow specific behaviors to receive the optimal charge (not parking at the same charger as another vehicle) and this may not be intuitive with 4 cables per charger.

### Power Conversion Devices at a Centralized Location

This charging architecture leads to smaller charge pillars in the carpark. One advantage is to save substantially on-site cabling costs if DC is routed for the final run to the carpark, assuming it is a long stretch. A split architecture used in some system (such as Tritium PK350 or Tritium PKM, for example) is even more advantageous for cabling, as the DC power is transmitted at higher voltage, compared with fully centralized options who must allow for the highest battery charge current. Another advantage is more optimal utilization of the power electronics on site, by diverting power only to the charging plugs which require it. This can allow a concentrated bank of power electronics to service a larger number of vehicles by splitting or sharing power.

There are different methods of performing this power sharing. This is complicated by the requirement for galvanic isolation for each vehicle from others. This usually needs complicated mechanical switching arrangements leading to inflexibility, where only some power modules can be routed to only some plugs. The mechanical switches involved can be a failure point.

Some architectures take a highly optimized approach to galvanic isolation, integrating it into the MV substation transformer with multiple output windings. This saves cost and substantially improved the efficiency of the power electronics. A drawback is that the distribution transformer, being non-standard, causes difficulty for local utilities and this can affect the scalability of the architecture across multiple jurisdictions.

One attempted solution (documented in PCT/AU2021/051522) involves the use of a common DC bus, with galvanically isolated DC/DC charging stations drawing power as required from the common bus.

Another possible implementation of a power sharing arrangement requires a customized DC distribution panel with DC isolation and protection. This has the problem that sites require detailed customization and the responsibility to design this might fall to the equipment manufacturer or the customer.

In yet another possible implementation. a standard DC distribution panel is used, but this leads to a costly, oversized DC distribution panel to futureproof the site against long term needs.

### Utilization

Electric vehicles charging installations are known to have a high diversity factor (ratio of charging capability to charge being demanded). This aspect is well documented and corresponds to uptake of vehicles, reduced charge rate of traction batteries as they approach top-of-charge, and time taken for drivers to return to vehicles and cycle vehicles through parking spaces.

In the case of separated rectification and charging conversion stages, it can be possible to have more charging capacity (DC/DC conversion stage) than rectification capacity (AC/DC conversion stage) to optimize the capital efficiency of the site. The DC/DC installed hardware corresponds to the aggregate charging capability, while the AC/DC installed hardware corresponds to the maximum demand.

When a smaller pool of AC/DC conversion is matched to a larger pool of DC/DC conversion, the AC/DC can be said to be oversubscribed. Often, the capacity of AC/DC conversion could be installed to match the available AC feed to the site. This would mean there is no wasted AC/DC conversion hardware, and the usage of both the hardware and power feed would be optimized.

In some countries, charge point operators pay higher fees to an electrical utility for connection of a large feed. This charge represents the requirement for the utility to reserve capacity in case the available power is drawn. If the site with a heavy feed is not well utilized, this can lead to poor profitability, as electricity is not being sold to offset the ongoing connection fees. Oversubscribing the AC feed is a way to match the size of the feed to the expected power delivery rate of the site.

It is an object of the present invention to provide electric vehicle charging stations that can be configured based on a multitude of factors, including site layout, site utilization and customer need/demand.

### SUMMARY OF INVENTION

In an aspect, the invention provides an electric vehicle charging system comprising:
a rectification assembly including a AC/DC (Alternating Current/Direct Current) rectifier having an input connected to an AC power supply and an output for outputting a DC output and being configured to convert an AC input from the AC power supply to the DC output at a first voltage;
one or more charging assemblies electrically connected to the rectification assembly to receive the DC output from the AC/DC rectifier at an input and for connecting to and providing electric power to a battery of an electric vehicle at an output, each of the one or more charging assemblies including a DC/DC converter configured to convert the DC output at the first voltage to a different voltage suitable to charge the battery of the electric vehicle; and
wherein the rectification assembly includes one or more electric protection circuits, and wherein for each charging assembly, one electric protection circuit of the one or more electric protection circuits is connected between the output of the AC/DC rectifier and the input of each of the one or more DC/DC converters.

Preferably, the rectification assembly is located in a rectification assembly housing and the charging assembly is located in a charging assembly housing. The rectification assembly housing and the charging assembly housing are distinct and/or separate housings.

Preferably, the rectification assembly is a first rectification assembly and the electric vehicle charging system further comprises:
a second rectification assembly including an AC/DC rectifier having an input connected to an AC power supply and an output for outputting a DC output and being configured to convert an AC input from the AC power supply to the DC output at a first voltage;
wherein the first rectification assembly includes a second electric protection circuit; and
the second rectification assembly includes a first electric protection circuit, wherein the second electric protection circuit of the first rectification assembly is connected to the first electric protection circuit of the second rectification assembly between the output of the AC/DC rectifier of the first rectification assembly and the output of the AC/DC rectifier of the second rectification assembly to facilitate power sharing.

Preferably, the rectification assembly includes between one and three electric protection circuits. Preferably, the rectification assembly includes three electric protection circuits, wherein a power throughput capacity of the electric protection circuits is equal to a power output capacity of the AC/DC rectifier of the rectification assembly.

Preferably, the electric vehicle charging system comprises N rectification assemblies and up to N+2 charging assemblies, wherein up to two charging assemblies are connected to each rectification assembly. Preferably, each of the N rectification assemblies includes up to three electric protection circuits, wherein an electric protection circuit is connected between each of the rectification assemblies and a corresponding charging assembly. Preferably, an electric protection circuit of one of the N rectification assemblies is connected to an electric protection circuit of another of the N rectification assemblies. Preferably, up to two electric protection circuits of each of the N rectification assemblies is connected to two electric protection circuits of another two of the N rectification assemblies and one or more of the electric protection circuits of each of the N rectification assemblies is connected to a corresponding one or more charging assemblies.

Preferably, the electric vehicle charging system comprises N rectification assemblies and up to 2*N charging assemblies, wherein up to two charging assemblies are connected to each rectification assembly. Preferably, each of the N rectification assemblies includes up to three electric protection circuits, wherein an electric protection circuit is connected between each of the rectification assemblies and a corresponding charging assembly. Preferably, an electric protection circuit of each of the N rectification assemblies is connected to an electric protection circuit of every other of the N rectification assemblies. Preferably, an electric protection circuit of each of the N rectification assemblies is connected to an electric protection circuit of every other of the N rectification assemblies by a common DC busbar.

Preferably a DC power source and/or charging assembly is connected to the common DC busbar.

Preferably, each electric protection circuit comprises an isolation switch arrangement. Preferably, the isolation switch arrangement includes a fuse connected in series with a normally open contactor.

In another aspect, the invention provides a rectification assembly comprising:
an AC/DC (Alternating Current/Direct Current) rectifier having an input connected to an AC power supply and an output for outputting a DC output and being configured to convert an AC input from the AC power supply to the DC output at a first voltage; and
one or more electric protection circuits for connecting the AC/DC rectifier to a charging assembly or another AC/DC rectifier.

In another aspect, the invention provides a rectification assembly including a AC/DC rectifier having an input connected to an AC power supply and an output for outputting a DC output and being configured to convert an AC input from the AC power supply to the DC output at a first voltage;
one or more charging assemblies electrically connected to the rectification assembly to receive the DC output from the AC/DC rectifier at an input and for connecting to and providing electric power to a battery of an electric vehicle at an output, each of the one or more charging assemblies including a DC/DC converter configured to convert the DC output at the first voltage to a different voltage suitable to charge the battery of the electric vehicle; and
wherein the rectification assembly includes one or more electric protection circuits, and wherein for each charging assembly, one electric protection circuit of the one or more electric protection circuits is connected between the output of the AC/DC rectifier and the input of each of the one or more DC/DC converters.

In another aspect, the invention provides an AC/DC (Alternating Current/Direct Current) rectifier having an input connected to an AC power supply and an output for outputting a DC output and being configured to convert an AC input from the AC power supply to the DC output at a first voltage, and one or more electric protection circuits for connecting the AC/DC rectifier to a charging assembly or another AC/DC rectifier.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 illustrates a rectification assembly having a plurality of electric protection circuits according to an embodiment of the present invention;

FIGS. 2 and 2A illustrate an electric vehicle charging system according to an embodiment of the present invention;

FIGS. 3 and 3A illustrate an electric vehicle charging system interconnecting rectification assemblies;

FIGS. 4 and 4A illustrate an electric vehicle charging system interconnecting the rectification assemblies through a common DC busbar;

FIGS. 5 to 7 illustrate a scalable electric vehicle charging system;

FIGS. 8 and 8A illustrates a vehicle charging system incorporating a DC power source and/or a DC charger connected to the common DC busbar;

FIGS. 9A and 9B illustrates the isolation of the charging assemblies and rectification assemblies using the electric protection circuits;

FIGS. 10 and 11 illustrate the emergency power off features of the electric vehicle charging system;

FIG. 12 illustrates a single 400 kW electric protection circuit being replaced with 2×200 kW electric protection circuits;

FIG. 13 illustrates the electric vehicle charging system including a DC distribution hub; and

FIG. 14 illustrates an electric vehicle charging system including multiple daisy chained charging assemblies.

### DETAILED DESCRIPTION OF PREFERRED EMBODIMENTS

Embodiments of the present invention provide an electric vehicle charging system including a rectification assembly (RU) and a charging assembly (CS) which can be connected together using electric protection circuits, which are provided within the RU, to achieve either an AC fed stand-alone charging station, a distributed cascaded rectification cluster of {N} rectification assemblies with up to {N+2} satellite CS, or a distributed parallel rectification cluster of up to {N} rectification assemblies with up to {2*N} the number of satellite CS. The electric protection circuit facilitates the implementation of a DC mesh that is resilient and convenient to own and operate.

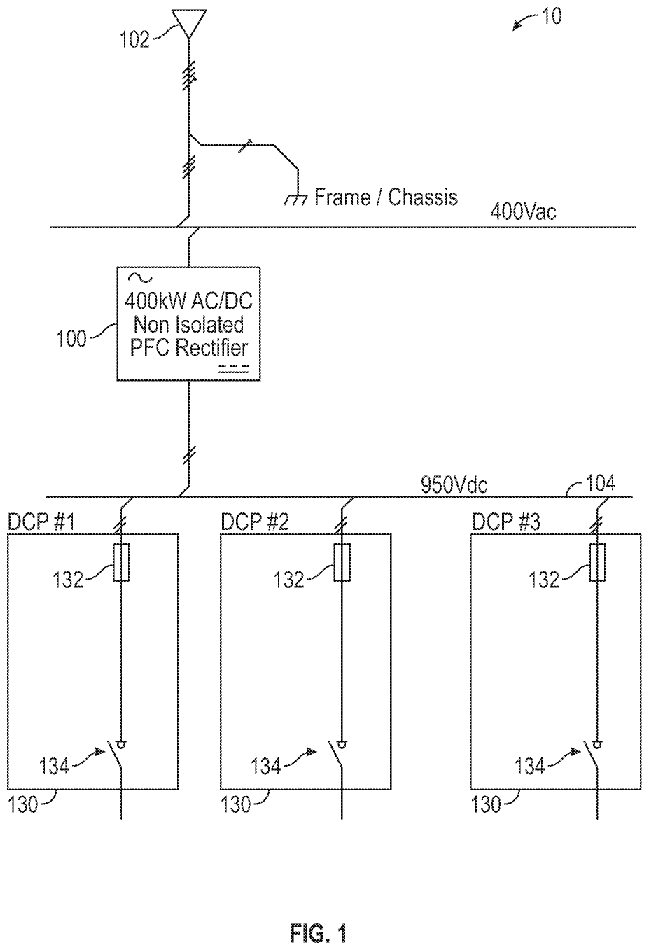

FIG. 1 illustrates rectification assembly 10 including an AC/DC (Alternating Current/Direct Current) rectifier 100 having an input connected to an AC power supply 102 and an output for outputting a DC output and being configured to convert an AC input from the AC power supply to the DC output at a first voltage, and one or more electric protection circuits 130 (three, in the illustrated embodiment) for connecting the AC/DC rectifier 100 to a charging assembly or another AC/DC rectifier.

The AC/DC rectifier 100 includes non-isolated power factor correction (PFC) rectification power electronics which receives AC power from the AC power supply 102 and converts the AC input to a DC output to feed power to an internal DC busbar 104. Each electric protection circuit 130 is connected to the internal DC busbar 104 (a 950V DC busbar in the illustration) such that each electric protection circuit 130 is an electrically protected output of the AC/DC rectifier 100.

The electric protection circuit 130 includes a fuse 132 connected in series with a normally open contactor 134. The normally open contactor 134 should be suitable for electrical isolation to allow for maintenance to be performed.

In some embodiments, the electric protection circuit includes a contactor for switching off and on an output from the AC/DC rectifier and an electrical isolation switch (which may be padlocked or otherwise have access that is physically/mechanically controlled, for example) for isolation so that maintenance can be safely conducted on the equipment.

In an electric vehicle charging system 1, multiple rectification assemblies 10 can be provided. Each rectification assembly 10 may include one or more electric protection circuits 130. In some embodiments, each rectification assembly 10 may include up to three (3) electric protection circuits 130.

The Inventors envision that three electric protection circuits of equal power rating provide some useful advantages (explained below) when the AC/DC rectifiers have substantially similar or equal power ratings to the three electric protection circuits.

As noted above, each electric protection circuit 130 is connectable to a charging assembly or another rectification assembly 10. Suitably, where a rectification assembly 10 includes multiple electric protection circuits 130, the rectification assembly 10 can be connected to both a charging assembly (or multiple charging assemblies) and a rectification assembly (or multiple rectification assemblies).

Where an electric protection circuit 130 is connected to a charging assembly, the electric protection circuit 130 can be connected to the charging assembly by an electric cable.

Where an electric protection circuit 130 is connected to another rectification assembly 10, the electric protection circuit 10 can be connected to the rectification assembly 10 by an electric cable. The connection of multiple rectification assemblies 10 provides for the implementation of a DC mesh provided by a DC bus link that facilitates power sharing between two or more rectification assemblies that are electrically connected.

Advantageously, the electric protection circuit 130 can be used to isolate an individual charging assembly from other charging assemblies or rectification assemblies, so that the charging assembly can be maintained, preserving charger availability. Similarly, the electric protection circuit 130 can also be used to isolate the rectification assembly 10 from other rectification assemblies or charging assemblies, so that the remaining rectification assemblies and charging assembly in the network can remain active and available.

The electric protection circuit 130 being integrated into the rectification assembly 10 provides a number of features, including:
a. Electrical protection: The electric protection circuit includes electrical protective devices to protect buried cables or the DC bus link;
b. Isolation for maintenance: The electric protection circuit includes a mechanical disconnect to fully electrically isolate cabinets from the DC bus for the purposes of maintenance; and
c. Emergency power off: The electric protection circuit includes an electrical contactor to rapidly interrupt load current and isolate cabinets from the DC bus if a door is inadvertently opened, or another critical system requests a trip.

As each rectification assembly 10 integrates the required electric protection circuit to connect multiple charging assemblies and a connection between multiple rectification assemblies (for power sharing) the DC protection capability of the site scales with the installed AC/DC capability (i.e. number of RUs). This avoids the need for a dedicated DC distribution panel.

In particular, the integration of the DC protection (a number of DC Ports) into each rectification assembly allows the site to be scaled to meet the demand without introducing complexity involved in DC distribution or protection. Furthermore, it allows for multiple configurations, as discussed herein.

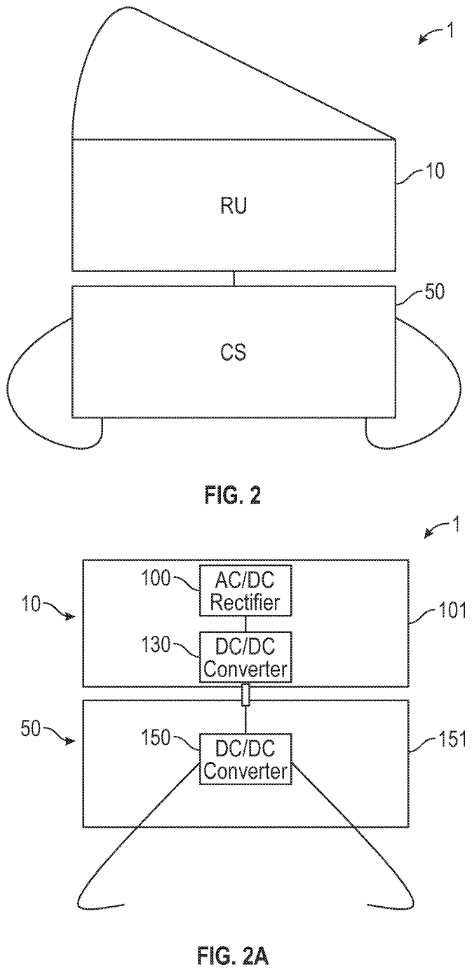

Turning to FIGS. 2 and 2A, a housing 101 for a rectification assembly 10 and a housing 151 for a charging assembly 50 are electrically connected back-to-back to form an electrical vehicle charging system 1. As such, the housing 101 for the rectification assembly 10 and the housing 151 for the charging assembly 50 are distinct and/or separate housings that may be placed back to back (and in some embodiments, physically connected together) with electrical connections between the respective rectification assembly 10 and charging assembly 50.

The rectification assembly 10 is as described above. The charging assembly 50 is electrically connected to the rectification assembly 10 to receive the DC output from the AC/DC rectifier 100 at an input and for connecting to and providing electric power to a battery of an electric vehicle at an output.

One or more charging assemblies 50 may be connected to a rectification assembly 10.

Each charging assembly 50 includes a DC/DC converter 150 configured to convert the DC output at the first voltage to a different voltage suitable to charge the battery of the electric vehicle 12.

In this embodiment, the rectification assembly 10 may optionally include an electric protection circuit 130 connected between the output of the AC/DC rectifier 100 and the input of the DC/DC converter 150 of the charging assembly 50. In this particular embodiment, the electric protection circuit 130 is optional as there are no adjoining cables, charging assemblies or rectification assemblies that the rectification assembly and/or charging assembly need to be electrically isolated from.

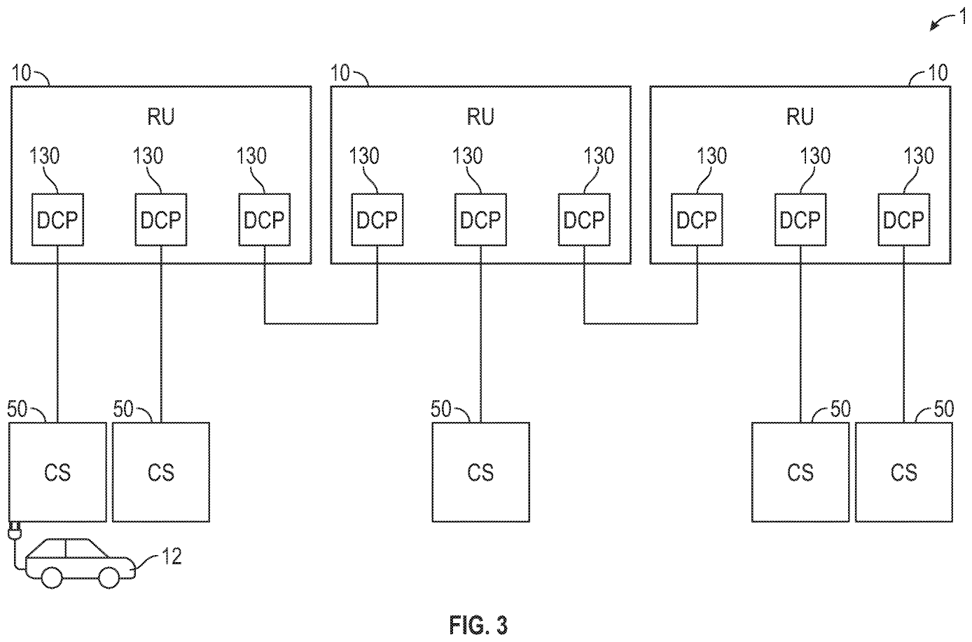

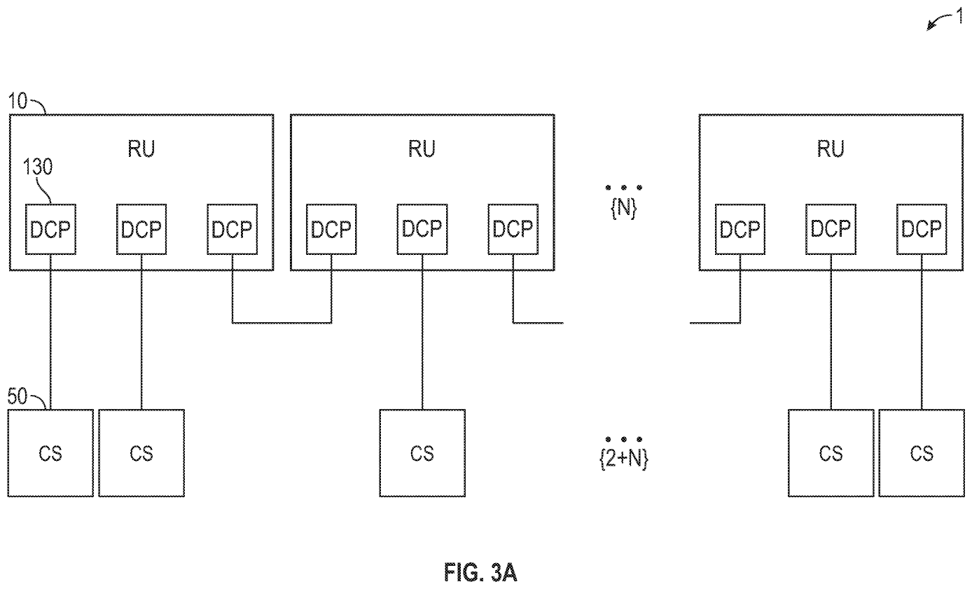

In another embodiment illustrated in FIG. 3, the electric vehicle charging system 1 comprises N rectification assemblies 10 and up to N+2 charging assemblies 50. In this embodiment, each rectification assembly 10 is connected to up to a combined total of three charging assemblies 50 and rectification assemblies 10. That is, each rectification assembly 10 is connected to up to two charging assemblies 50 and each rectification assembly 10 is connected to up to two other rectification assemblies 10, where the total number of charging assemblies 50 and rectification assemblies 10 connected to each rectification assembly 10 does not exceed three.

Each of the N rectification assemblies 10 can include up to three electric protection circuits 130, wherein an electric protection circuit 130 is connected between each of the rectification assemblies 10 and a corresponding charging assembly 50. Furthermore, an electric protection circuit 130 of one of the N rectification assemblies 10 may be connected to an electric protection circuit 130 of another of the N rectification assemblies 10.

In the illustrated embodiment of FIG. 3A, two electric protection circuits 130 of each of the N rectification assemblies 10 is connected to two electric protection circuits 130 of another two of the N rectification assemblies 10. Furthermore, one or more (that is, one or two) of the electric protection circuits 130 of each of the N rectification assemblies 10 is connected to a corresponding one or more charging assemblies 50.

The possible configurations include:
(1) Each rectification assembly 10 may be connected to one other rectification assembly 10 and two charging assemblies 50; or
(2) Each rectification assembly 10 may be connected to two other rectification assemblies 10 and one charging assembly 50.

The embodiments described above in relation to FIGS. 3 and 3A are envisioned to be particularly useful when the charging site is a brown-fields site and is space constrained. In such situations, rectification assemblies could be scattered in multiple locations where it is convenient to locate them. In this case, buried cable or above-ground cables can be used to connect an electric protection circuit 130 of a rectification assembly 10 to an electric protection circuit 130 on the next rectification assembly 10 in the “cascade” chain, as shown in FIG. 3.

The rectification assemblies 10 on the end of the chain can support up to two (2) charging assemblies 50. The rectification assemblies 10 in the middle of the chain only have one electric protection circuit 130 remaining to connect to a charging assembly 50.

If N of the rectification assemblies 10 are installed, N+2 charging assemblies 50 can be installed to create a more capital efficient utilization of the rectification hardware. In this configuration, power can be shared across the site by shunting power along the cascade chain from one end to the other.

In this embodiment, some advantages are envisioned where three electric protection circuits are provided. If the output capacity of the rectification assemblies is P(RU) and the throughput capacity of the electric protection circuits is P(DCP) where P(RU)=P(DCP), let maximum power draw from the charging station/charging assembly P(CS)=P(RU)=P(DCP).

At the ends of the chain (i.e. the outside assemblies), power output of the AC/DC rectifiers of the rectification assemblies is P(CS)+P(CS) and power input to the AC/DC rectifiers of the rectification assemblies is P(RU)+P(DCP). That is, with all devices on each rectification assembly operating at full power (400 kW, for example), no component would be overloaded.

For the middle rectification assembly, the power output of the AC/DC rectifiers of the rectification assemblies is P(CS)+P(DCP) and power input to the AC/DC rectifiers of the rectification assemblies is P(RU)+P(DCP). Again, the rectification assembly is capable of supplying the single charging station/charging assembly and shifting power to either of the other two rectification assemblies and charging stations/charging assemblies that may require the additional power.

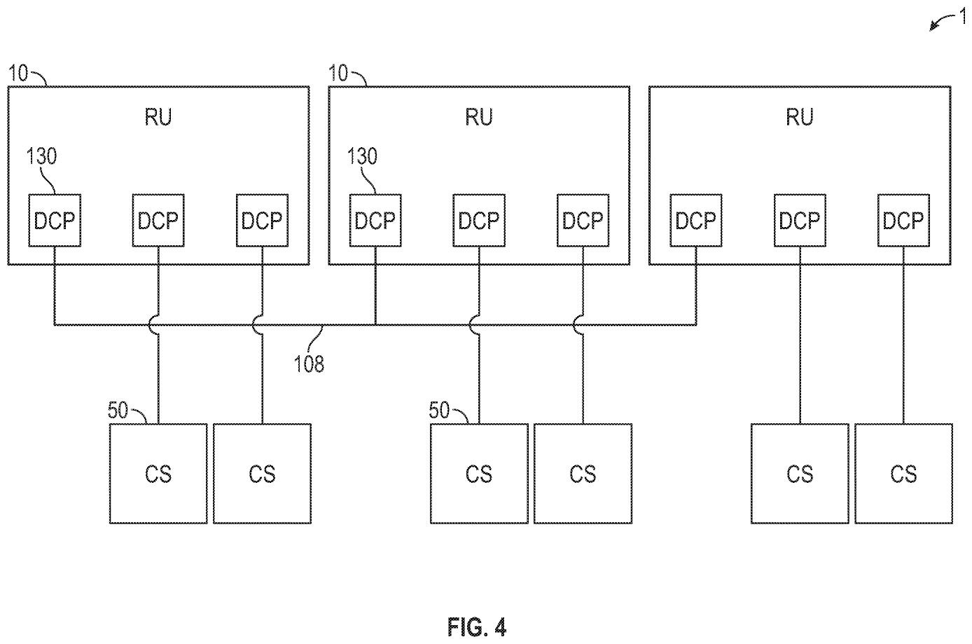

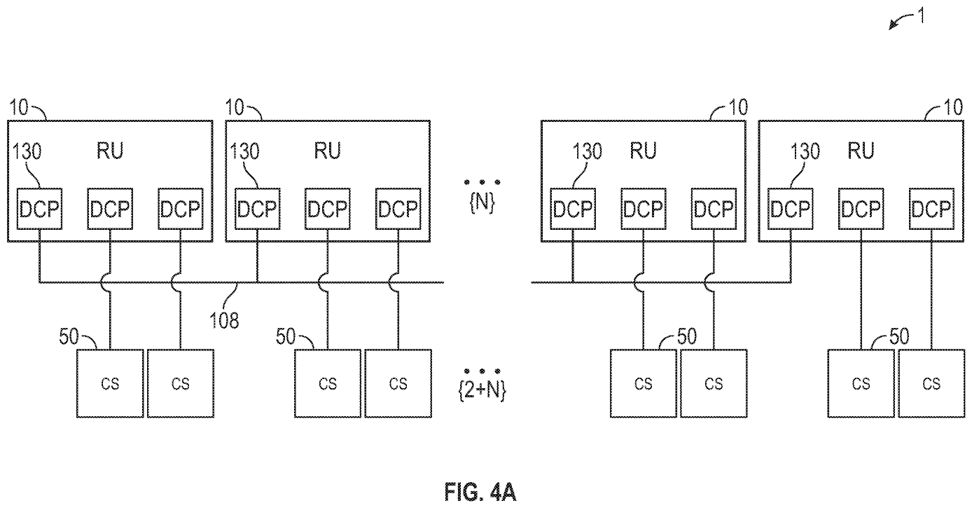

In another embodiment illustrated in FIGS. 4 and 4A, the electric vehicle charging system 1 comprises N rectification assemblies 10 and up to 2*N charging assemblies 50, wherein up to two charging assemblies 50 are connected to each rectification assembly 10.

In this embodiment, each rectification assembly 10 is connected to every other of the N rectification assembles 10 and up to two (2) charging assemblies 50.

Each of the N rectification assemblies 10 includes up to three electric protection circuits 130, wherein an electric protection circuit 130 is connected between each of the rectification assemblies 10 and a corresponding charging assembly 50. Furthermore, an electric protection circuit 130 of each of the N rectification assemblies 10 is connected to an electric protection circuit 130 of every other of the N rectification assemblies 10. This interconnection of every rectification assembly 10 with every other rectification assembly 10 of the N rectification assemblies 10 is provided by an electric protection circuit 130 of each rectification assembly 10 being connected to a common DC busbar 108.

Assuming that maximum power output of the AC/DC rectifier of the rectification assembly (P(RU)) is substantially or roughly equal to the maximum power throughput of the electric protection circuits, the size of the common DC busbar 108 can be determined by CEILING(N/2)*P(RU), where CEILING( ) rounds up to the nearest integer and N is the number of AC/DC rectifiers in the system. In some embodiments, it is envisioned that only a portion of the common DC busbar 108 connected to the middle rectification assembly or assemblies in a parallel configuration (see FIG. 4) must be sized according to the above formula. However, for convenience and to reduce complexity associated with design, configuration and installation, it is envisioned that the busbar would be uniformly sized.

This embodiments also provides similar advantages to those described above in relation to the cascaded configuration illustrated in FIGS. 3 and 3A.

The embodiments described above in relation to FIGS. 4 and 4A are envisioned to be particularly useful when the charging site is a green-fields site and there is ample room to create a centralized bank of rectification assemblies standing back-to-back and side-by-side. In such situations, rectification assemblies 10 can be connected by the common DC busbar 108, as shown in FIG. 4. Each rectification assembly 10 in the bank has an electric protection circuit 130 connected by a short “feeder tap” to the common DC busbar 108. The rectification assembly 10 also has two spare electric protection circuits 130, each of which can be connected to a charging assembly 50.

In an advantage of this embodiment, a greater oversubscription ratio (allowing a higher diversity factor for the site while minimizing the spend on rectification assemblies 10) can be achieved, where {N} of the rectification assemblies 10 can be connected to {2×N} of the charging assemblies 50, even for large sites.

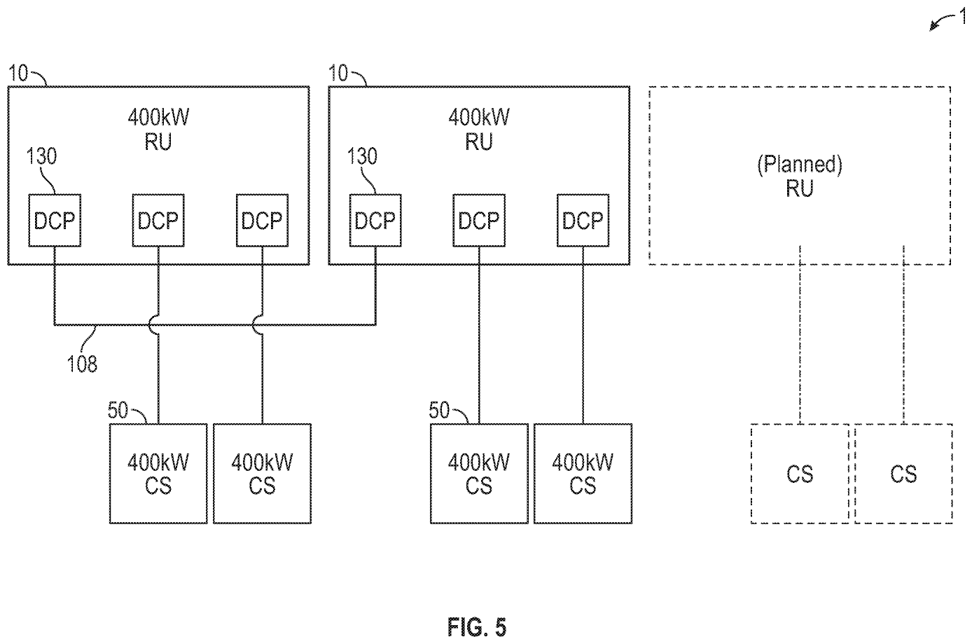

With reference now to FIG. 5, an example of a new site in a parallel distributed configuration (the embodiment described above in relation to FIGS. 4 and 4A) is shown.

The dotted lines indicate planned upgrades that are allowed for in the foundations and installation of buried conduits.

The electric vehicle charging system 1 in FIG. 5 has 800 kW of AC/DC rectification provided by the two (2) rectification assemblies 10 and 1.6 MW of DC/DC charging capability provided by the four (4) charging assemblies 50.

The AC/DC rectification is said to be oversubscribed by a factor of 2:1. If each charging assembly 50 has a 200 kW load, the AC/DC rectifiers of the rectification assemblies 10 will be considered to be very well utilized even though the site is underutilized. If 400 kW vehicles arrive to charge, they can still achieve their full charge rate if not too many other vehicles are charging.

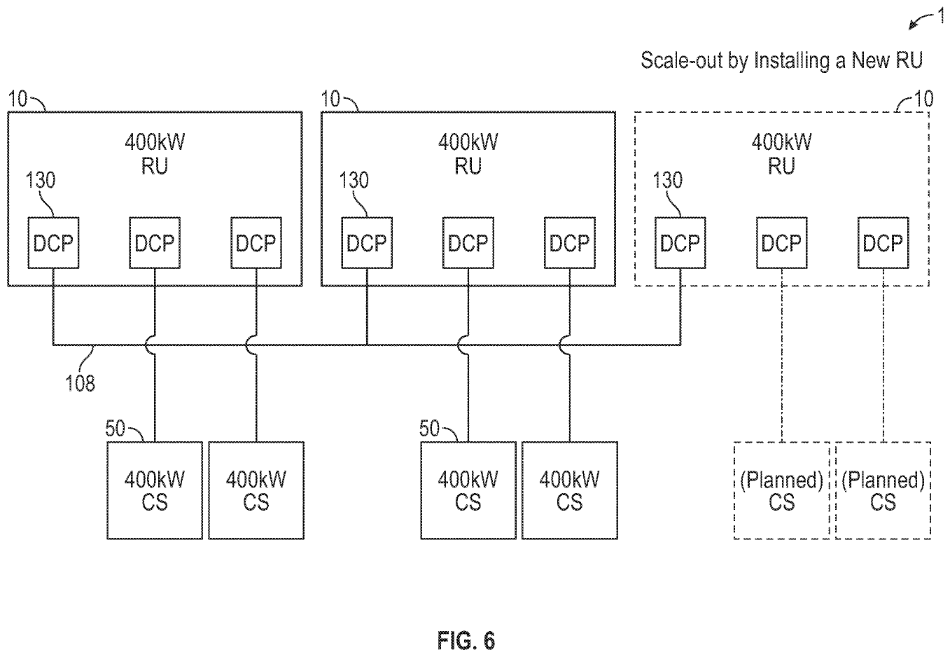

In the future, if the site becomes popular, or technology improvements lead to more predominance of 400 kW vehicles, another rectification assembly may be added, as shown in FIG. 6.

The electrical vehicle charging system 1 in FIG. 6 has 1.2 MW of charging available versus 1.6 MW of total charging capacity, and thus would be oversubscribed by a factor of 4:3.

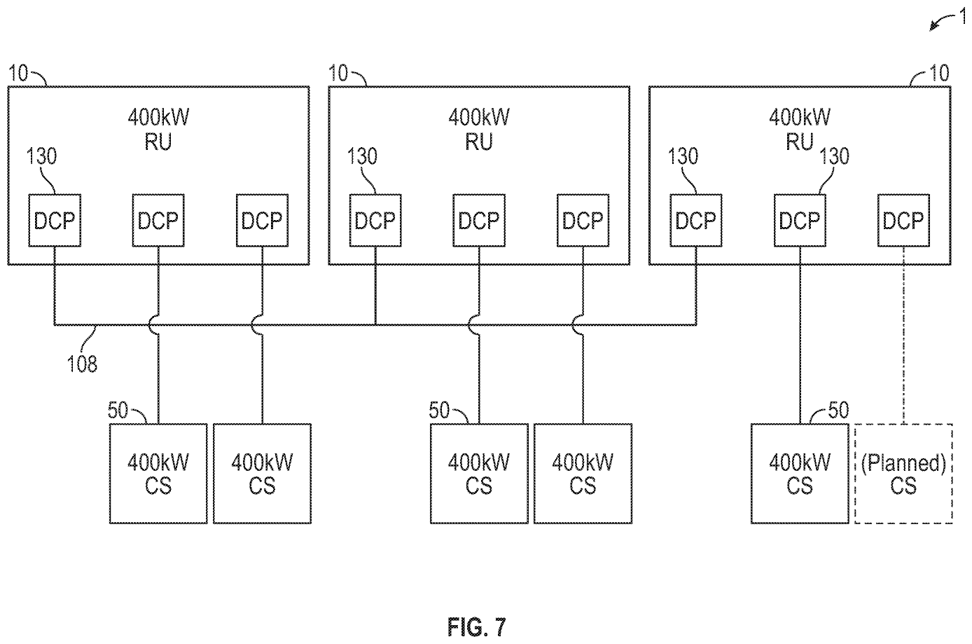

Turning to FIG. 7, an additional charging assembly 50 is added. An additional charging assembly may be added in response to a number of factors. For example, as the site continues to be used, the CPO notices that queue times are increasing at the site, and the charging assembly is sometimes idle while a driver is refreshing themselves and returning to the vehicle. The electric vehicle charging system 1, while in high demand with vehicles queueing, is often only drawing 1 MW out of a possible 1.2 MW of AC/DC feed. The CPO could at this time scale-up the site by adding one of the final two planned charging assemblies, as shown in FIG. 7. The oversubscription rate is increased slightly (from 4:3 to 5:3), but the site is optimized to sell the most electricity as additional vehicles can be plugged in charging.

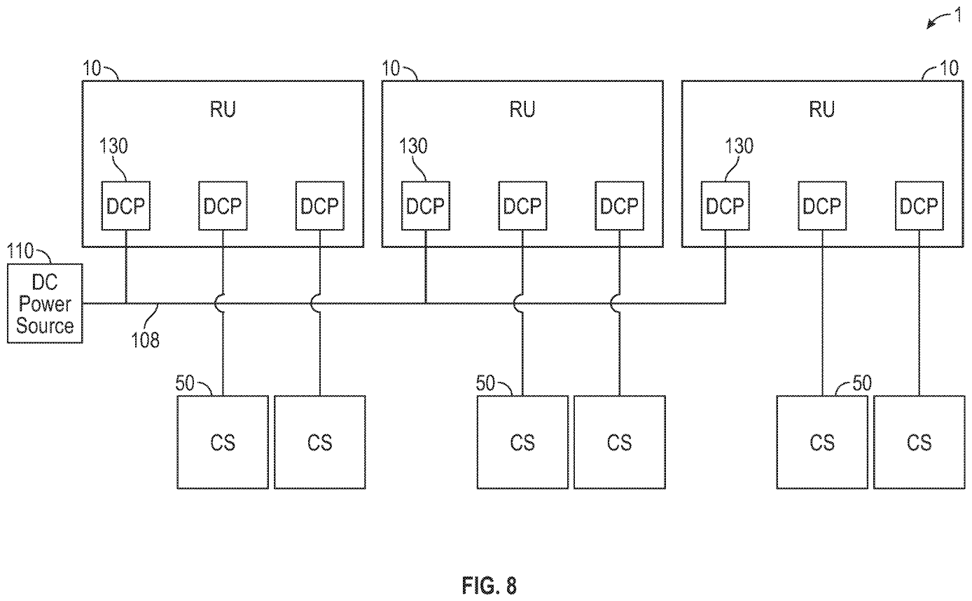

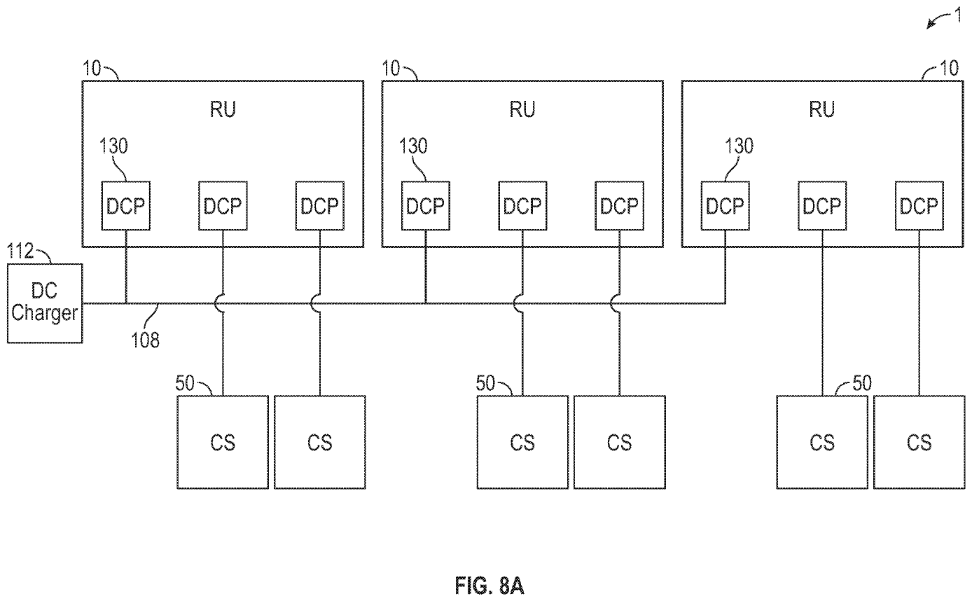

In FIGS. 8 and 8A, an additional charging assembly is connected to the rectification assembly to bring the oversubscription rate to 2:1.

FIGS. 8 and 8A also illustrate the integration of distributed generation and/or storage. The integration of distributed generation and/or storage includes the integration of DC power sources 110, such as solar, wind or a battery energy storage system, for example. The hardware required to do so is significantly more economical than using multiple conversion stages to connect the DC source to the AC point of common coupling.

The DC busbar 108 between the rectification assemblies 10 in the parallel distributed configuration provides an ideal point to connect these additional generators, as shown in FIG. 8.

In FIG. 8A, an additional DC charger 112 (preferably a high power DC charger, such as a 1 MW charging station, for example) could be connected to utilize the full site power available from all of the rectification assemblies 10 in the electric vehicle charging system 1.

The Inventors have identified that the provision of a DC mesh requires parts of the electric vehicle charging system to be isolated from each other so that individual components can be serviced while the electric vehicle charging system continues to operate. As it will surely be appreciated, without isolation, the entire electric vehicle charging system would need to go offline for routine and unscheduled maintenance being conducted on any individual component (e.g., rectification assembly or charging assembly).

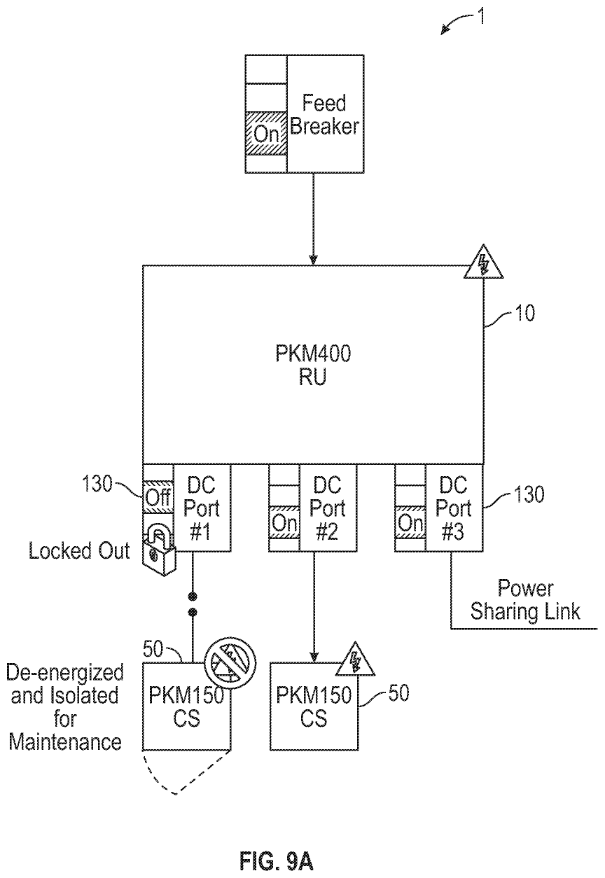

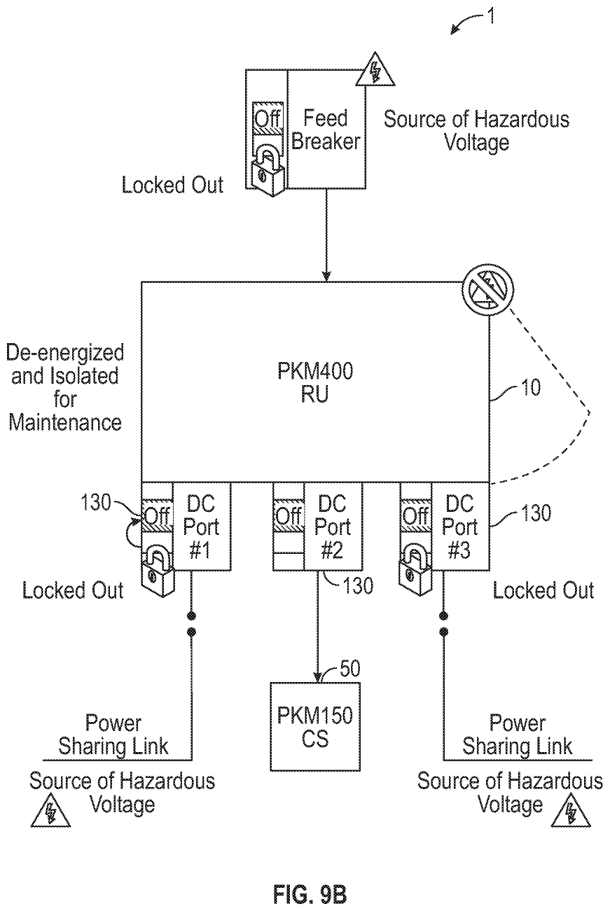

In FIGS. 9A and 9B, examples of isolating an individual charging assembly 50 and isolating an individual rectification assembly 10, respectively, are shown.

The isolation switch arrangement of each electric protection circuit 130 provides for sources of hazardous voltage to be isolated. This provides electrical isolation and thus protection for technicians so that the technicians can safely service the equipment.

In FIG. 9A, the electric protection circuit 130 has been opened to prevent power flowing to one of the charging assemblies 50 to allow the de-energised charging assembly 50 to be worked for maintenance purposes.

In FIG. 9B, the AC power supply has been disconnected and every electric protection circuit 130 in the rectification assembly 10 has been opened to prevent power flowing to the rectification assembly 10 from other rectification assemblies and/or charging assemblies to allow the de-energised rectification assembly 10 to be worked for maintenance purposes.

The isolation switch arrangement of the electric protection circuit 130 also provides emergency power off (EPO) capabilities. The EPO capabilities provides trip signals that can be very reliably correlated to the origin of a hazardous voltage.

The contactors in the electric protection circuit 130 provide for the detection of contactors that fails to open using mirror contacts which trigger a backup trip which de-energizes a larger section of the electric vehicle charging system or, in some embodiments, all of the electric vehicle charging system.

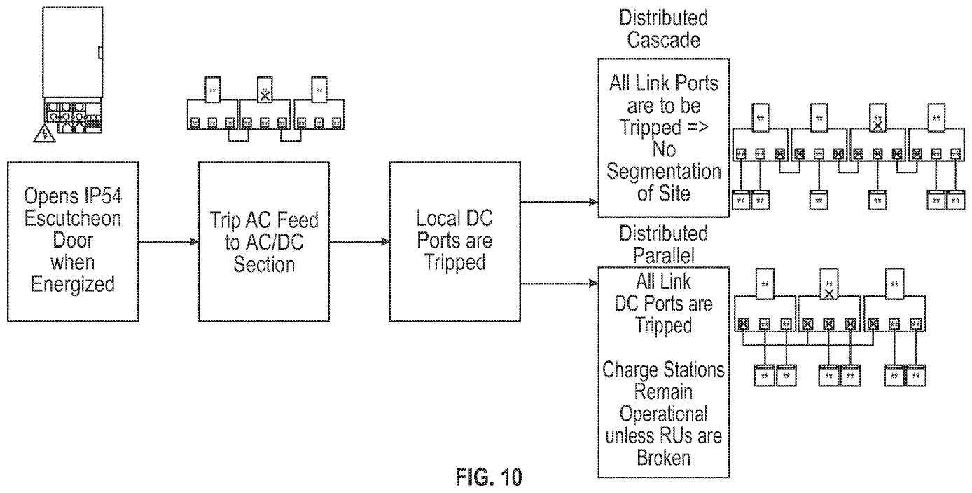

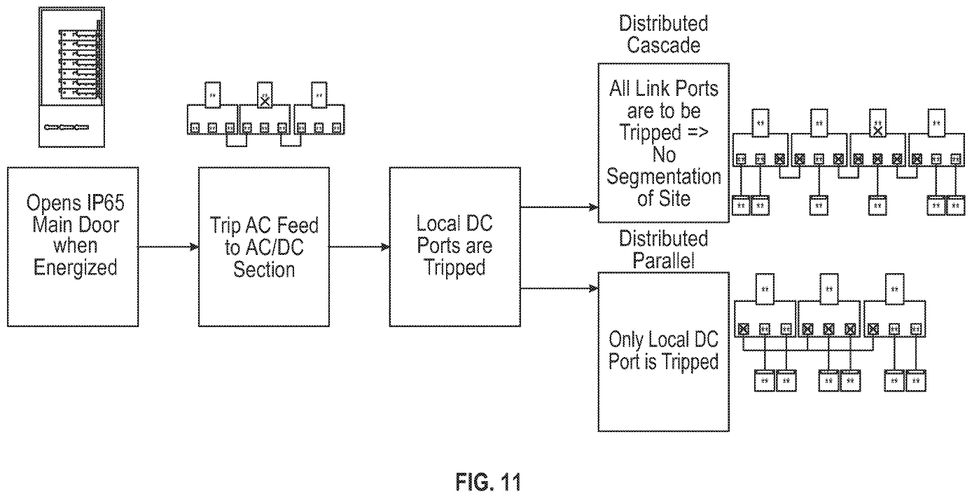

The Inventors envision that the EPO may be a point of unreliability in the electric vehicle charging system due to false triggers that may be caused by a loose or broken connection. In response, EPO trip requests from a cabinet only cause isolation at points as necessary to make that cabinet safe. For example, in the distributed parallel configuration, power sharing can remain active and charge stations can continue to charge, as shown in FIGS. 10 and 11. Furthermore, in the distributed cascade configuration charge stations can continue to charge, as shown in FIGS. 10 and 11.

The EPO feature can trip all electric protection circuits on a distributed cascade site if it is not desired to have a segmented site. Segmented sites cause additional problems with reliable power sharing, as shown in FIGS. 10 and 11.

An advantage of embodiments of the present invention is that charging assemblies of different power can be provided while all being fed from a common DC bus.

In an example, an electric vehicle charging system could include one charging assembly at 400 kW (suitable for fast charging) in combination with a number of additional charging assemblies at 40 kW.

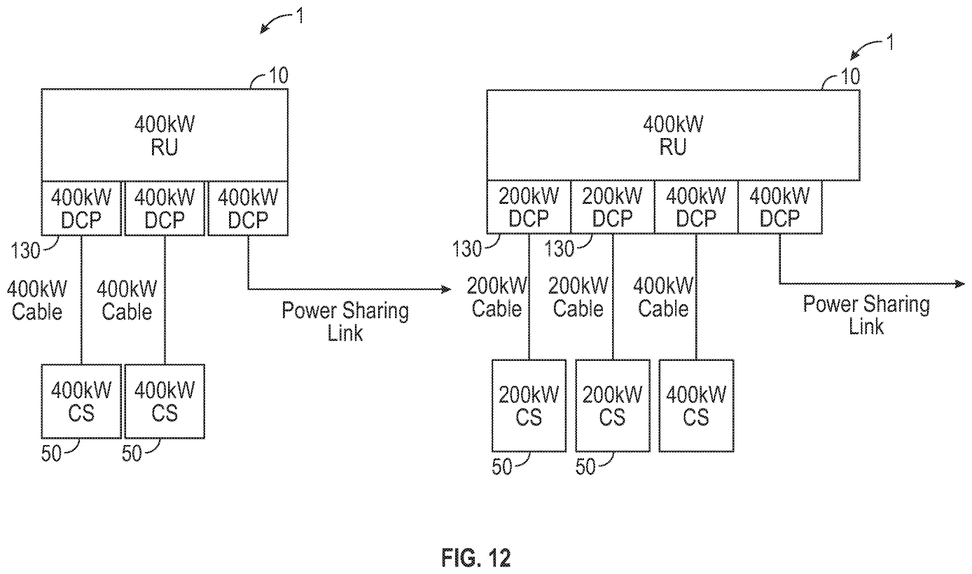

In some embodiments, electric protection circuits 130 having different power ratings/capacities can be provided within a single rectification assembly. For example, as illustrated in FIG. 12, two (2) electric protection circuits 130 with ratings of 200 kW (shown in (b)) can be provided in place of a single 400 kW rated electric protection circuit 130 (shown in (a), and earlier embodiments and illustrations) which can in turn be connected to two (2) 200 kW charging assemblies 50.

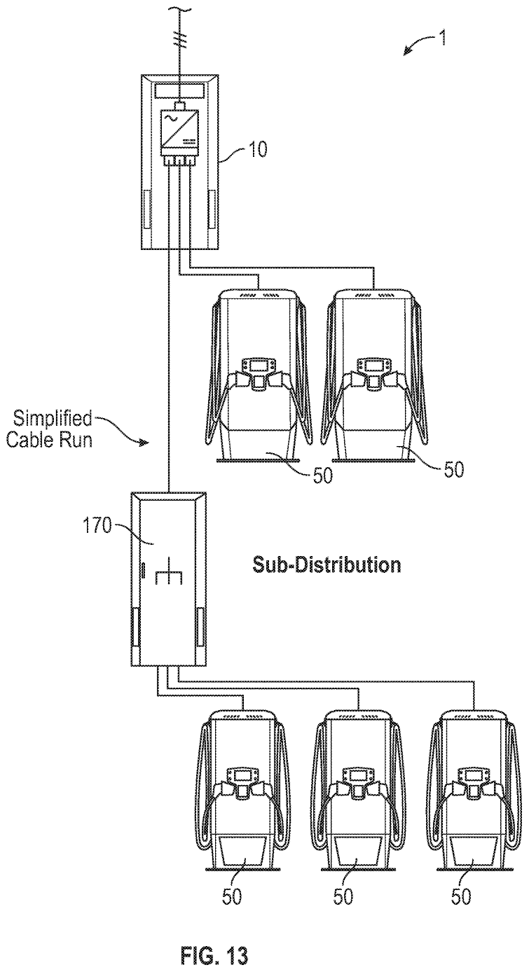

In some further embodiments, such as that illustrated in FIG. 13, where there is a long or large distance between the rectification assembly and the associated charging assembly, it may be desirable to provide a sub-distribution assembly 170. An alternative solution requires the running of many long cables terminating at multiple charging assemblies which is complex and time consuming. A sub-distribution assembly 170 may include one or more electric protection circuits (as described above). The sub-distribution assembly provides a “hub and spoke” connection arrangement. This type of connection arrangement can be advantageous as long runs between a rectification and charging assembly that would usually require multiple cables can be provided with a single cable. This reduces oversizing of cables due to group factor derating and simplifies the installation. A DC distribution hub can be located close to a group of physically close charging assemblies to protect the final cable run to the charging assembly.

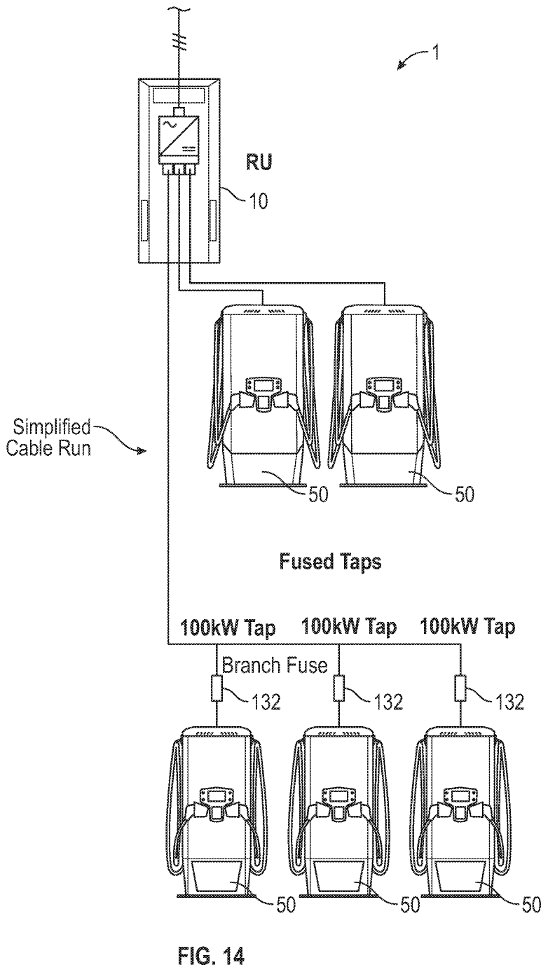

In some embodiments, such as charging at a workplace, for example, it may be desirable to utilise a centralised rectification assembly. This can be achieved by providing a rectification assembly having a number of electric protection circuits (up to three) connected to a number of charging assemblies 50 having a first power rating, where the number of charging assemblies 50 having the first power rating is less than the maximum number of electric protection circuits 130. Additional charging assemblies 50a that have a second power rating (less than the first power rating) can then be connected directly to the remaining, unused electric protection circuit or electric protection circuits with a fuse 132 sufficiently rated for the second power rating connected between each of the additional charging assemblies 50a and the electric protection circuit 130. An example of this implementation can be seen in FIG. 14.

In one embodiment, although it need not be the only or indeed the broadest embodiment, there is provided:
an AC/DC rectifier connected to an AC power supply, the AC/DC rectifier being configured to convert an AC input to a DC output; and
a DC/DC converter electrically connected to the AC/DC rectifier to receive the DC output from the AC/DC rectifier and for connecting to and providing electric power to a battery of an electric vehicle, the DC/DC converter being configured to convert the DC output from a first voltage to a second voltage suitable to charge the battery of the electric vehicle,
wherein the AC/DC rectifier is physically separated from the DC/DC converter.

In another embodiment, there is provided a rectification assembly including a AC/DC rectifier having an input connected to an AC power supply and an output for outputting a DC output and being configured to convert an AC input from the AC power supply to the DC output at a first voltage;
one or more charging assemblies electrically connected to the rectification assembly to receive the DC output from the AC/DC rectifier at an input and for connecting to and providing electric power to a battery of an electric vehicle at an output, each of the one or more charging assemblies including a DC/DC converter configured to convert the DC output at the first voltage to a different voltage suitable to charge the battery of the electric vehicle; and
wherein the rectification assembly includes one or more electric protection circuits, and wherein for each charging assembly, one electric protection circuit of the one or more electric protection circuits is connected between the output of the AC/DC rectifier and the input of each of the one or more DC/DC converters.

In some embodiments, there is provided an AC/DC (Alternating Current/Direct Current) rectifier having an input connected to an AC power supply and an output for outputting a DC output and being configured to convert an AC input from the AC power supply to the DC output at a first voltage, and one or more electric protection circuits for connecting the AC/DC rectifier to a charging assembly or another AC/DC rectifier.

Embodiments of the invention can provide a cost-effective, scalable infrastructure for installing large charging hubs. Embodiments of the invention allow EV charger providers (known as charge point operations or CPOs) to match their equipment purchase to the diversity factor, site layout and objectives at the time of installation while allowing for modular changes over time as requirements change.

Embodiments of the invention aim to increase average utilization of the AC/DC hardware with respect to the peak utilization.

As the EV landscape matures, and uptake of vehicles increases, the diversity factor may naturally reduce. Embodiments of the invention provide for the installation of additional AC/DC cabinets in a future upgrade, bringing higher charge delivery and increased profits.

Some CPOs use AC supplied charging stations adjacent to the vehicle parking spot. Others prefer to save space in the vehicle parking spot and footpath by centralizing the AC/DC conversion stage of the charger at an out-of-the-way location. This also allows for a large cable cost reduction due to DC reticulation at elevated voltage. Embodiments of the invention provide for both. For example, depending on the goals of the CPO, embodiments of the invention provide for higher reliability by using additional redundant cabinets. Embodiments of the invention support this need for redundancy of rectification assembly cabinets in that power sharing between all rectification assembly cabinets is possible. Therefore, it is very likely that a failure of one, or even multiple cabinets, may go unnoticed by most customers.

In compliance with the statute, the invention has been described in language more or less specific to structural or methodical features. The term “comprises” and its variations, such as “comprising” and “comprised of” is used throughout in an inclusive sense and not to the exclusion of any additional features.

It is to be understood that the invention is not limited to specific features shown or described since the means herein described comprises preferred forms of putting the invention into effect.

The invention is, therefore, claimed in any of its forms or modifications within the proper scope of the appended claims appropriately interpreted by those skilled in the art.

1. An electric vehicle charging system comprising:
a rectification assembly including an AC/DC (Alternating Current/Direct Current) rectifier having an input connected to an AC power supply and an output for outputting a DC output and being configured to convert an AC input from the AC power supply to the DC output at a first voltage;
one or more charging assemblies electrically connected to the rectification assembly to receive the DC output from the AC/DC rectifier at an input and for connecting to and providing electric power to a battery of an electric vehicle at an output, each of the one or more charging assemblies including a DC/DC converter configured to convert the DC output at the first voltage to a different voltage suitable to charge the battery of the electric vehicle; and
wherein the rectification assembly includes one or more electric protection circuits, and wherein for each charging assembly, one electric protection circuit of the one or more electric protection circuits is connected between the output of the AC/DC rectifier and the input of each of the one or more DC/DC converters.

2. The electric vehicle charging system of claim 1, wherein the rectification assembly is located in a rectification assembly housing and the charging assembly is located in a charging assembly housing.

3. The electric vehicle charging system of claim 1, wherein the rectification assembly is a first rectification assembly and the electric vehicle charging system further comprises:
a second rectification assembly including an AC/DC rectifier having an input connected to an AC power supply and an output for outputting a DC output and being configured to convert an AC input from the AC power supply to the DC output at the first voltage;
wherein the first rectification assembly includes a second electric protection circuit; and
the second rectification assembly includes a first electric protection circuit, wherein the second electric protection circuit of the first rectification assembly is connected to the first electric protection circuit of the second rectification assembly between the output of the AC/DC rectifier of the first rectification assembly and the output of the AC/DC rectifier of the second rectification assembly to facilitate power sharing.

4. The electric vehicle charging system of claim 1, wherein the rectification assembly includes between one and three electric protection circuits.

5. The electric vehicle charging system of claim 1, wherein the rectification assembly includes three electric protection circuits, and a power throughput capacity of the electric protection circuits is equal to a power output capacity of the AC/DC rectifier of the rectification assembly.

6. The electric vehicle charging system of claim 1, wherein the electric vehicle charging system comprises N rectification assemblies and up to N+2 charging assemblies, and up to two charging assemblies are connected to each rectification assembly.

7. The electric vehicle charging system of claim 6, wherein each of the N rectification assemblies includes up to three electric protection circuits, and an electric protection circuit is connected between each of the rectification assemblies and a corresponding charging assembly.

8. The electric vehicle charging system of claim 6, wherein an electric protection circuit of one of the N rectification assemblies is connected to an electric protection circuit of another of the N rectification assemblies.

9. The electric vehicle charging system of claim 6, wherein up to two electric protection circuits of each of the N rectification assemblies is connected to two electric protection circuits of another two of the N rectification assemblies and one or more of the electric protection circuits of each of the N rectification assemblies is connected to a corresponding one or more charging assemblies.

10. The electric vehicle charging system of claim 6, wherein the electric vehicle charging system comprises N rectification assemblies and up to 2*N charging assemblies, and up to two charging assemblies are connected to each rectification assembly.

11. The electric vehicle charging system of claim 6, wherein an electric protection circuit of each of the N rectification assemblies is connected to an electric protection circuit of every other of the N rectification assemblies.

12. The electric vehicle charging system of claim 6, wherein an electric protection circuit of each of the N rectification assemblies is connected to an electric protection circuit of every other of the N rectification assemblies by a common DC busbar.

13. The electric vehicle charging system of claim 12, wherein a DC power source and/or charging assembly is connected to the common DC busbar.

14. The electric vehicle charging system of claim 1, wherein each electric protection circuit comprises an isolation switch arrangement.

15. The electric vehicle charging system of claim 14, wherein the isolation switch arrangement includes a fuse connected in series with a normally open contactor.

16. A rectification assembly comprising:
an AC/DC (Alternating Current/Direct Current) rectifier having an input connected to an AC power supply and an output for outputting a DC output and being configured to convert an AC input from the AC power supply to the DC output at a first voltage; and
one or more electric protection circuits for connecting the AC/DC rectifier to a charging assembly or another AC/DC rectifier.

17. A rectification assembly including a AC/DC rectifier having an input connected to an AC power supply and an output for outputting a DC output and being configured to convert an AC input from the AC power supply to the DC output at a first voltage;
one or more charging assemblies electrically connected to the rectification assembly to receive the DC output from the AC/DC rectifier at an input and for connecting to and providing electric power to a battery of an electric vehicle at an output, each of the one or more charging assemblies including a DC/DC converter configured to convert the DC output at the first voltage to a different voltage suitable to charge the battery of the electric vehicle; and
wherein the rectification assembly includes one or more electric protection circuits, and wherein for each charging assembly, one electric protection circuit of the one or more electric protection circuits is connected between the output of the AC/DC rectifier and the input of each of the one or more DC/DC converters.

18. An AC/DC (Alternating Current/Direct Current) rectifier having an input connected to an AC power supply and an output for outputting a DC output and being configured to convert an AC input from the AC power supply to the DC output at a first voltage, and one or more electric protection circuits for connecting the AC/DC rectifier to a charging assembly or another AC/DC rectifier.
